(19) United States
(12) Patent Application Publication
(10) Pub. No.: US 2026/0079556 A1
(43) Pub. Date: Mar. 19, 2026

(54) AUTOMATIC IMPLEMENTATION OF DEVICE SETTINGS FOR ENERGY EFFICIENCY

(71) Applicant: Lenovo Global Technology (United States) Inc., Morrisville, NC (US)

(72) Inventors: John C. Mese, Cary, NC (US); Mark Delaney, Raleigh, NC (US); Nathan Peterson, Oxford, NC (US); Russell S. VanBlon, Raleigh, NC (US)

(21) Appl. No.: 18/888,668

(22) Filed: Sep. 18, 2024

(51) Int. Cl. G06F 1/3234; G06F 1/3206

(52) U.S. Cl. CPC G06F 1/3234; G06F 1/3206

(57) ABSTRACT

One embodiment provides a method, the method including: generating, utilizing an efficiency budgeting system, an energy efficiency budget for a computing device; automatically implementing energy consumption settings for the computing device to meet the energy efficiency budget for the computing device; and dynamically modifying, using the efficiency budgeting system, the energy consumption settings based upon computational resource requirements for the computing device requested by the user and in view of the energy efficiency budget. Other aspects are claimed and described.

### BACKGROUND

Devices utilize many different processing resources for performing different tasks. Processing resources may include memory, graphics processing units (GPUs), central processing units (CPUs), and/or the like. In addition to processing resources, the devices also utilize and control other components, for example, displays, fans, projectors, communication devices (e.g., near-field communication devices, short-range communication devices, network communication devices, etc.), and/or the like. All of the processing resources and other components require power to function and control. An increased use in the processing resources or other components requires more power or energy as compared to a reduced use in the processing resources or other components.

Many different factors may increase the use of processing resources or other components. For example, some applications may require more processing resources or the use of certain components as compared to other applications. For example, software coding applications may require more processing resources as compared to email applications. As another example, different environmental factors may require an increase in processing resources or use of certain components. As an example, a hot room may require an increase in fan speed to keep the device cool as compared to a cooler room. Thus, the utilization of processing resources and other components can vary over periods of time.

### BRIEF SUMMARY

In summary, one aspect provides a method, the method including: generating, utilizing an efficiency budgeting system, an energy efficiency budget for a computing device; automatically implementing energy consumption settings for the computing device to meet the energy efficiency budget for the computing device; and dynamically modifying, using the efficiency budgeting system, the energy consumption settings based upon computational resource requirements for the computing device requested by the user and in view of the energy efficiency budget.

Another aspect provides a system, the system including: a processor; a memory device that stores instructions that, when executed by the processor, causes the system to: generate, utilizing an efficiency budgeting system, an energy efficiency budget for a computing device; automatically implement energy consumption settings for the computing device to meet the energy efficiency budget for the computing device; and dynamically modify, using the efficiency budgeting system, the energy consumption settings based upon computational resource requirements for the computing device requested by the user and in view of the energy efficiency budget.

A further aspect provides a product, the product including: a computer-readable storage device that stores executable code that, when executed by a processor, causes the product to: generate, utilizing an efficiency budgeting system, an energy efficiency budget for a computing device; automatically implement energy consumption settings for the computing device to meet the energy efficiency budget for the computing device; and dynamically modify, using the efficiency budgeting system, the energy consumption settings based upon computational resource requirements for the computing device requested by the user and in view of the energy efficiency budget.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for automatically implementing device settings for devices to meet an energy efficiency budget for a computing device and dynamically modifying the settings based upon requested resource requirements.

### DETAILED DESCRIPTION

Since the use of processing resources and components can vary over time, users may adjust settings on a device to account for the maximum needed processing resource and component use. In other words, if a user performs tasks that require high uses of processing resources, the user does not want to set a limit for use of the processing resources that would no longer allow the user to perform the desired or necessary task. The problem with this is that it means that the device is using more energy than is necessary for performing other tasks that do not require the high processing capabilities or use of components. For example, a person who routinely performs software coding and compiling may need significantly more processing resources to accomplish these tasks. Thus, the person may set the limit for processing resources high enough to perform these tasks. However, when the user then views and responds to emails, the system still allocates and/or utilizes excess processing resources, even when not needed for performing such tasks.

By having resource utilization and component usage set to levels to allow users to perform all tasks, the device is using more energy than is what is necessary. In other words, the energy efficiency of the device is not optimal or even close to optimal. In addition to not being energy efficient, the use of more processing resources than required can be detrimental to the device in other ways. For example, increased use of processing resources decreases the lifespan of these resources and the device overall, can increase heat generated by the device which has a detrimental effect on the lifespan of the device and components of the device, and/or the like.

One technique for increasing the energy efficiency of the device is to implement a power policy. Example power policies may include a battery-saving power policy, better-performance power policy, and/or the like. Selecting a power policy will cause the device to implement different settings, for example, sleep settings (e.g., how long without input or action before the device will be put to sleep, how long before the screen is turned off, etc.), how to treat peripheral devices based upon inaction, when to turn on a screen saver, and/or the like. A power policy that prioritizes performance over energy-saving will be less efficient than a battery-saving power policy. One problem with selecting power policies is that the power policy is set for a group of settings, even if the user may only need one setting to be changed. Additionally, once the user selects the power policy, it is maintained until the user changes the selection. While a user may make such selections when a device is set up, unless a user is having performance issues or is dedicated to changing the power policy, the policy may never be changed.

Current operating systems may have some techniques that allow a user to increase the energy efficiency of their device. For example, some operating systems include an application that makes recommendations to the user regarding energy recommendations. As the user selects or implements the energy recommendations, the system may indicate how well the settings increase the energy efficiency of the device. Users may want to try to achieve a maximum energy efficiency of the device, so they may adjust the settings until the desired level of energy efficiency is met. While the user is able to adjust settings individually, unlike with the selection of a power policy, the settings may only be modified on rare occasions. Thus, if the user has set the device settings to provide performance benefits, the user may never change the settings to increase the energy efficiency. Similarly, if the user has set the device settings to provide energy efficiency, the user may struggle to perform tasks that require increased performance. Some device manufacturers may provide additional system or device settings that allow a user additional customization, but these suffer from the same shortfalls as mentioned above.

Accordingly, the described system and method provides a technique for automatically implementing device settings for devices to meet an energy efficiency budget for a computing device and dynamically modifying the settings based upon requested resource requirements. An efficiency budgeting system generates an energy efficiency budget for a computing device and/or for a set of computing devices. In generating the budget, the system may generate a budget for an entity and then attribute or allocate a portion of that budget to a particular device or set of devices. The entity may be a company, a division of a company, a group of a company, or any other entity or portion of an entity. Additionally, attributing or allocating the portion of the budget to a particular device may include attributing a portion of the overall budget to a group (e.g., to a group of devices, to a group of users, etc.) and then attributing a portion of the group budget to a device within the group. In other words, attributing the portion of the budget may include multiple layers of allocations.

Based upon the energy efficiency budget generated for or allocated to the device, the system automatically implements settings for the device to meet the device budget. Implementing settings may include adjusting settings on the device that are able to be correlated to energy settings. Thus, example settings include, but are not limited to, CPU usage, discrete graphics versus integrated graphics usage, memory resource usage, display settings, peripheral component usage or activation, sleep settings, inactivity timeouts, fan speed, and/or the like. As the user is utilizing the device, the system can dynamically modify the settings based upon resource requirements requested by the user. In other words, as the user is utilizing the device to perform different tasks, the system monitors what the user is doing or other factors and modifies the settings in view of these factors. For example, if the CPU usage is capped but the user is attempting to compile code, the CPU usage cap may need to be increased, at least temporarily, in order to perform the desired task properly. Similarly, the system monitors different factors and if the settings can be further restricted in order to conserve energy without affecting performance, the system may further modify the settings. Modifying the settings may be based upon any number of factors including, but not limited to, applications that the user is utilizing, environmental contexts or factors, a specific user that is utilizing the device and characteristics of the user, schedules of the user, and/or the like.

Therefore, a system provides a technical improvement over traditional methods for establishing device settings, particularly for energy efficiency. Instead of static device settings that are only adjusted by a user manually changing the settings, the described system provides a dynamic adjustment of the settings based upon an energy budget for the device and resource requirements by the user. By providing the dynamic modification of the settings, the described system provides a technique to make devices more energy efficient, without sacrificing performance when needed by the user. Thus, the described system provides a method and a system that not only increases energy efficiency, but can also increase device lifespan and decrease other detrimental effects on the device.

The illustrated example embodiments will be best understood by reference to the figures. The following description is intended only by way of example, and simply illustrates certain example embodiments.

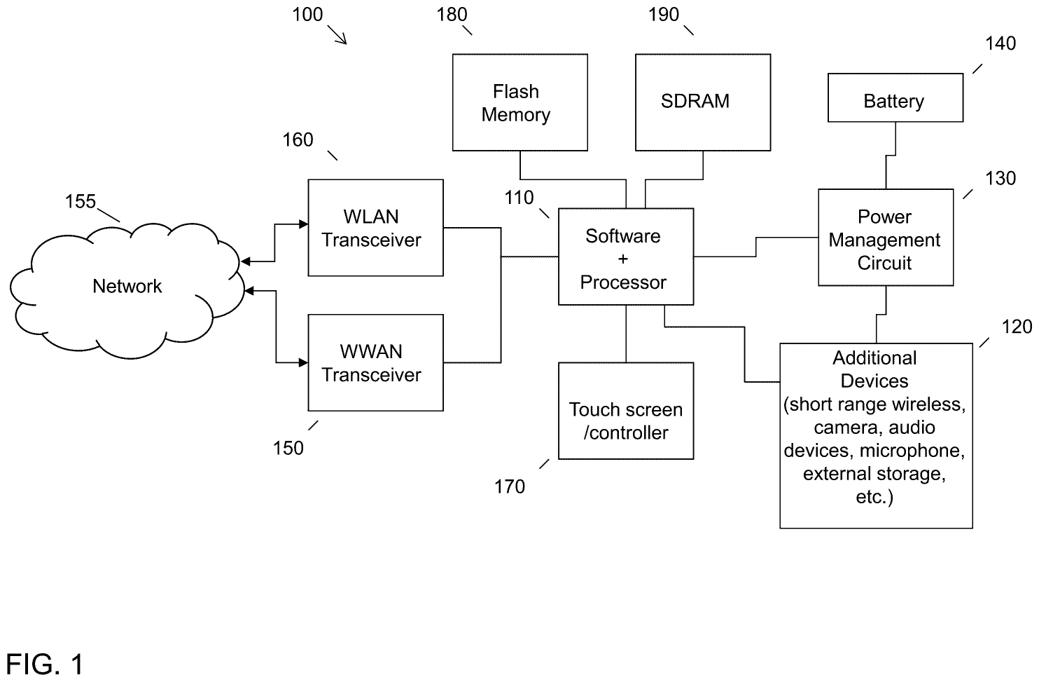

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

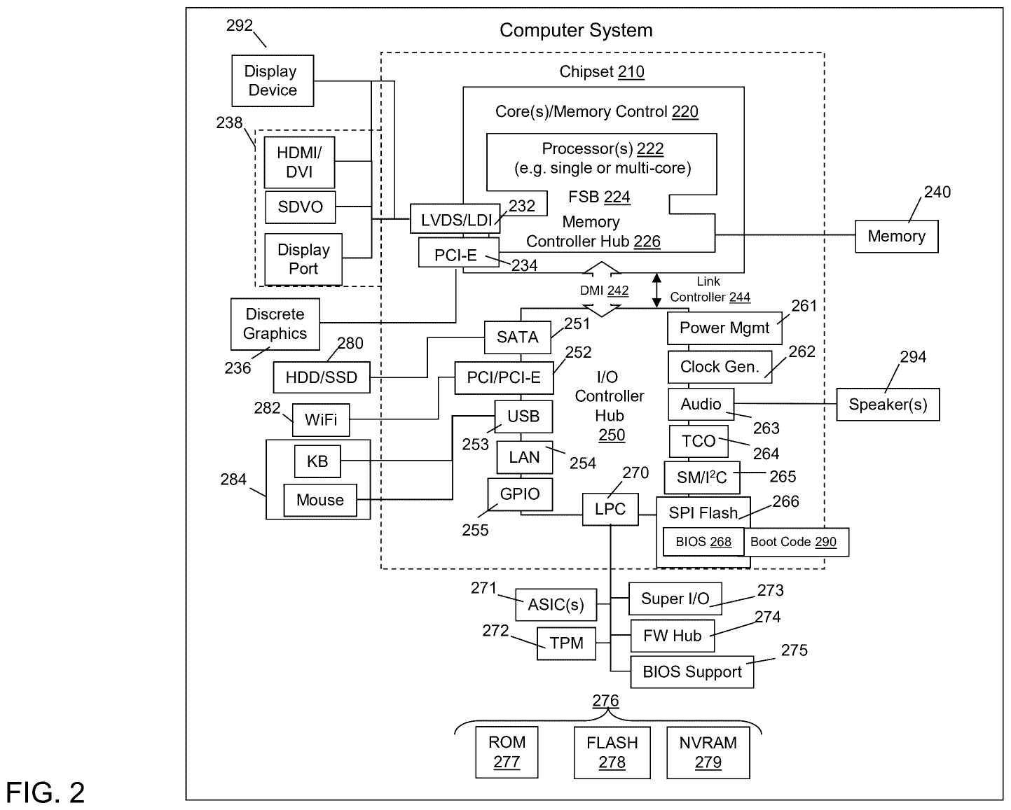

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used by users to perform different tasks and that may utilize the efficiency budgeting system to implement device settings based upon an energy efficiency budget. For example, the circuitry outlined in FIG. 1 may be implemented in a tablet or smart phone embodiment, whereas the circuitry outlined in FIG. 2 may be implemented in a personal computer embodiment.

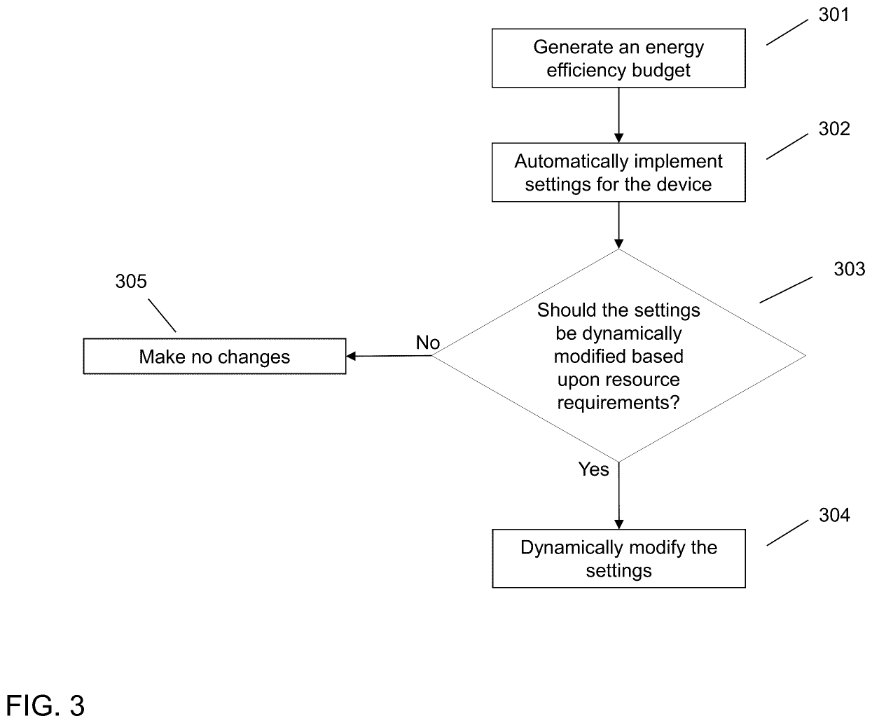

FIG. 3 illustrates an example method for automatically implementing device settings for devices to meet an energy efficiency budget for a computing device and dynamically modifying the settings based upon requested resource requirements. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to implement settings for a device based upon a generated energy efficiency budget. Additionally, the efficiency budgeting system includes modules and features that are unique to the described system.

Activation of the efficiency budgeting system may be a manual activation of the efficiency budgeting system and/or an automatic activation of the efficiency budgeting system. Manual activation of the system may include a user opening an application associated with the efficiency budgeting system, the user accessing the computing system associated with the efficiency budgeting system, and/or the user otherwise providing input to the efficiency budgeting system. The automatic activation of the efficiency budgeting system may be based upon the detection of a trigger event indicating that the system should be activated. Example trigger events include a user accessing a device that has an energy efficiency budget, detection of a user changing device settings, detection of a user utilizing a device that would require modification of device settings, activation of software or an application utilizing the efficiency budgeting system, and/or the like.

The efficiency budgeting system may be made of multiple systems or modules that communicate together to make up the efficiency budgeting system or may be a single system. The efficiency budgeting system may be a standalone system, may be accessible through other computing devices, and/or a combination thereof. For example, the efficiency budgeting system may be a standalone system that can be accessed by a user and/or may be or provide an application that is accessible by a user on another computing device. The efficiency budgeting system may be accessible using any type of computing device, for example, personal computer, laptop computer, smartphone, tablet, smartwatch, head-mounted display, smart television or other smart appliance, augmented reality device, virtual reality device, and/or the like. Thus, the efficiency budgeting system may be accessible locally using a computing device where the efficiency budgeting system is installed and/or may be accessible remotely through another computing device. For example, the efficiency budgeting system may be accessed by a user using a device that communicates with the efficiency budgeting system to generate an energy efficiency budget, using a device that has an energy efficiency budget, using a device to change device settings, access profiles for the efficiency budgeting system, and/or the like. However, the efficiency budgeting system may be located and operate on a different information handling device to perform the described steps.

The generation of an energy efficiency budget can be provided as a service to other entities or companies. In other words, the efficiency budgeting system could be stored on a server or network of a company and the system could generate energy efficiency budgets for other companies or entities, with the other companies or entities paying for the generation of energy efficiency budgets or use of the efficiency budgeting system.

The efficiency budgeting system may have an associated graphical user interface. The graphical user interface may be provided on a display or monitor, which may or may not be associated with the efficiency budgeting system. In other words, the efficiency budgeting system may have a dedicated display or monitor or may be accessible using any display or monitor. In either case, the efficiency budgeting system may provide instructions to generate and display the graphical user interface on the display device being used to access the efficiency budgeting system. The graphical user interface may also be updated and managed based upon instructions provided by the efficiency budgeting system. In other words, the efficiency budgeting system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the efficiency budgeting system. For example, the efficiency budgeting system may utilize a user/entity profile, device profile, historical information, and/or the like, to identify when an energy efficiency budget should be generated, when the settings for a device should be implemented and to what values, when the device settings should be dynamically modified, and/or the like. The graphical user interface may allow for creation of or access to these profiles, historical information, and/or the like, by allowing a user to input and/or modify information regarding user preferences, device information, entity information and preferences, budget allocation, and/or the like. As will be discussed in more detail, the use of user provided information is not the only way that the profile and/or historical information can be created. The efficiency budgeting system can then utilize these inputs to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display information of the profiles, generated energy efficiency budgets, allocated energy efficiency budgets, device settings, and/or the like. It should be noted that the information to be used by the efficiency budgeting system and information provided by the efficiency budgeting system can be different for different applications, different computing systems, different users, and/or the like. Thus, the information corresponding to input or output of the efficiency budgeting system are not always the same. However, the efficiency budgeting system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The efficiency budgeting system may utilize one or more artificial intelligence models in generating an energy efficiency budget and implementing device settings in view of the budget. Artificial intelligence models could be designed to generate the energy efficiency budgets, determine what device settings can be modified and to what values to meet the energy efficiency budget, determine when device settings should be modified and to what values, or any other steps within the described system. Artificial intelligence models may also be used for steps within a step. For example, a model could be utilized to perform an analysis to identify a current energy efficiency of a device, identify information about a user or device that allows for identification of when device settings should be set to particular values, and/or the like. For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the efficiency budgeting system or may be a model that is created from scratch. Since the efficiency budgeting system is used in conjunction with generation and implementation of an energy efficiency budget, some models that may be utilized by the system are device analysis models, other analysis models, similarity identification models, language models, large language models, filtering models, classification models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The efficiency budgeting system may include different components for carrying out different functions of the system, including different steps to be performed. These components may be hardware components or software components. Some hardware devices or components that may be utilized by the efficiency budgeting system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the efficiency budgeting system. For example, the efficiency budgeting system may include speakers, displays or monitors, haptic output devices, audio output devices, and/or the like. Other hardware components may include data storage devices, including on devices of the user (e.g., mobile device, personal computer, laptop, tablet, smart watch, etc.), devices or components of the efficiency budgeting system, and/or the like.

Some software components include a user/entity profile or a device profile. The user/entity profile may include information that is unique to a user or entity that could be used by the efficiency budgeting system when generating the energy efficiency budget. For example, an entity profile may include information related to a number of devices within an entity, a number of groups or departments within an entity, types of devices within an entity, which devices within the entity should be subjected to an energy efficiency budget, working hours or use hours for devices within the entity, what portion of the entity efficiency budget should be attributed to particular groups or devices, and/or any other information that may be useful for generating an energy efficiency budget and then allocating it to different devices within the entity. Since the generation of an energy efficiency budget may be performed as a service for different entities, each entity profile may be different with different energy efficiency budgets and different allocations for devices within the entity.

The entity may be a company, a single user, a small group of users (e.g., within a home network, within a friend group, etc.), and/or the like. In other words, the entity may be as small as a single user having a single device or multiple devices to as large as a multinational corporation that has thousands of employees with devices. Thus, while an entity profile may be discussed in the context of a user using a device within a company or corporation, it should be noted that the energy efficiency system can also be used by a single user or small group of users, for example, at home, across a few devices within a home network, and/or the like.

The entity profile may also identify a range for the energy efficiency budget. For example, rather than a simple energy efficiency cap, the budget may include an ideal value which corresponds to a target value that may be difficult but not impossible to reach, a satisfactory value which corresponds to a target value that is expected or easy to reach, and a maximum value which corresponds to the cap efficiency value. Other values may be utilized or included. Additionally, less than the aforementioned values may be included. The energy efficiency budget may decrease over time after devices or users are more aware of energy that is being used, thereby reducing the energy use of the entity over time.

The entity may keep track of which devices or users are performing the best against the energy efficiency budget. For example, the entity may keep track of which users or devices are under their allocated energy efficiency budget, how much certain devices or users are under the budget, and/or the like. This information may be normalized against a time of use of the device, thereby allowing an even comparison across users and devices. In other words, and as an example, an energy efficiency calculation for a user who only used a device for 8 hours in a week would be normalized to be compared to a user who utilized a device for 40 hours in the same week. Accordingly, the entity profile may include this information so that it accessible by the entity. The entity could utilize this information to create a leaderboard or competition so as to encourage others to meet or exceed the energy efficiency budget allocated to their device.

Entities may also provide incentives for meeting or exceeding an energy efficiency budget. Incentives may include energy credits, entity store credits, performance awards, credits toward time off, and/or the like. In other words, incentives could be any type of incentive that the entity would like to award to a user. The entity could identify the incentives and the requirements for obtaining an incentive and this information could be stored within the entity profile. The entity profile could be accessible by the entity and could be modified by the entity as desired. Thus, even if the efficiency budgeting system is provided as a service to an entity, the entity could control the entity profile or even store some of this information at a different data storage location and the information captured by the energy efficiency system could be transmitted to that data storage location for use by the entity.

A user profile may correspond to a particular user that may utilize a device or a number of devices. The user profile may be updated over time with information gleaned about a user over time, either through user input, user monitoring, the use of artificial intelligence models which may learn about the user over time, and/or the like. The user profile may include information about the user which could be used to identify when device settings could be set to maximum energy efficiency or need to be maximum performance, or somewhere in between. Thus, the user profile may include information related to a role of the user, applications that the user utilizes, when the user may use particular applications, environments that the user may utilize a device within, contexts of the device when in use by the user, devices that are assigned to the user and that are subject to the energy efficiency budget, and/or any other information that may be useful for generating an energy efficiency budget, implementing device settings, and/or identifying when the device settings should be modified.

The user profile may include schedules that identify when a user utilizes a device and when the user does not utilize a device. For example, the schedule may identify that the user takes a lunch break every day around the same time. Thus, the user may not be utilizing certain devices. Accordingly, the device settings could be changed to correspond to maximum energy efficiency values. Similarly, the schedule may identify when the user performs particular tasks that require high performance or the use of particular processing resources or components. At these times, the device settings could be dynamically changed to allow for use of those processing resources or components without having a performance issue. In other words, the settings that correspond to those processing resources or components would be changed to be more performance oriented than energy efficiency.

The schedule may also identify locations where the user utilizes the device. Different locations may result in different performance expectations or component use. For example, in a work environment, a user device may be unable to utilize location services. Accordingly, the components related to identifying a location of the device could be deactivated. On the other hand, in the home environment, the location services may be usable and are thereby activated. As another example, in some locations the user may not want to connect to peripheral devices using short-range communication components. Accordingly, these components can be turned off in this location and turned on in other locations.

At 301, the efficiency budgeting system generates an energy efficiency budget for a computing device. The energy efficiency budget identifies how much energy should be used by a device over a period of time. Thus, the budget identifies a target amount of energy or a maximum amount of energy that can be utilized by a device for a period of time. It should be noted, that while the budget identifies a maximum amount of energy that can be utilized by a device and the system takes actions to decrease the amount of energy utilized by a device, the system generally does not prevent the device from exceeding the maximum amount of energy. In other words, if the device exceeds the energy efficiency budget, the system does not deactivate the device or prevent the device from functioning. However, if desired by a user, such actions could be a possibility. The energy efficiency budget may be generated at predetermined time periods and may be a budget for a particular period of time. For example, the budget may be generated for a day, over a week, over a month, over a quarter, over a year, and/or the like. In other words, the budget may include an identification of how much energy can be utilized by a device for a specific predetermined time period.

Generating of the energy efficiency budget may also include providing instructions to generate the energy efficiency budget. In other words, the device or system that generates the energy efficiency budget can be, but does not have to be, the same device that implements the device settings and modifies the device settings. For example, while the device settings may be implemented on a device, the energy efficiency budget could be generated on a different device. Accordingly, the device for which the settings would be implemented could send instructions or otherwise provide an indication to the energy efficiency budget generation device to generate the budget for the device. For ease of readability, the device to which the energy efficiency budget will allocated and settings will be modified or manipulated will be referred to as a user device, even though it may not be assigned to a specific user. The device or system that generates the energy efficiency budget will be referred to as the budget device or system. However, it should be noted that both the user device and the budget device could be the same device, or they could be separate devices.

As previously described, the energy efficiency budget could be generated for a single device or a group of devices. The group of devices could be multiple devices of a single person, devices of a small group of people, devices of a large entity, and/or the like. Thus, the energy efficiency budget can be generated for a single device or thousands or more devices. Accordingly, the energy efficiency budget may include an entity energy efficiency budget, a user energy efficiency budget, a device energy efficiency budget, a group of devices energy efficiency budget, and/or the like. In the case that an energy efficiency budget is created that encompasses a budget for more than one device, the system may allocate portions of the budget to each of the devices that the entire budget is intended to encompass.

In allocating portions of the budget for each device, the system may utilize information within the entity profile that identifies how the budget should be allocated. Additionally, or alternatively, the budget could be allocated equally or proportionally among the devices, allocated based upon percentage of use of each device, allocated based upon a role or job of a user of each device, and/or the like. In other words, the allocation of the budget can be performed using any number of techniques and can be highly configurable by a user or entity with respect to the budget allocation. Additionally, it should be noted that the budget can be portioned and allocated in multiple tiers or layers. For example, in an entity with different departments, an energy efficiency budget may be made for the entire entity. Portions of the budget can then be allocated to each of the departments. Portions of each of the budgets allocated to each of the departments can then be allocated to devices within the departments. Thus, in this example, the entity budget was portioned and allocated in two different layers. More or less layers are possible, as this is merely an example for understanding. Conversely, each department could generate an energy efficiency budget and the budgets for all departments could be aggregated to create the energy efficiency budget for the entity.

In generating the energy efficiency budget, the system may take into account energy goals for an entity. In other words, the energy efficiency budget may be made based upon energy goals for an entity. Thus, if an entity has goals to reduce the amount of energy utilized by the entity, the system may take this goal into account and make the energy efficiency budget so that if the budget is achieved, the entity would reduce energy utilization. If the entity has an amount to reduce energy efficiency by, the system may take this into account when making the budget. The energy efficiency budget may also have built in reductions. Thus, instead of making a budget that would dramatically reduce the energy utilization, the system may create a series of budgets that eventually gets the energy usage down to a desired or target amount over a period of time.

At 302, the system may automatically implement settings for the device. In other words, the system may automatically implement settings for the device to meet the energy efficiency budget that has been generated for the device or allocated to the device. Implementing the settings could be performed by the user device via the user device obtaining the energy efficiency budget from the budget device, determining what device settings should be changed and to which values the device settings should be set, and then actually setting the device settings. Alternatively, or additionally, the budget device could perform the analysis regarding what device settings should be changed and to which values the device settings should be set and then provide instructions to the user device regarding the device settings and setting values and the user device could then implement the device settings and setting values.

Implementing settings includes providing instructions to applications of the device that include device settings, providing instructions to the operating system of the device to implement the device settings, adjusting the settings directly, deactivating or activating particular components, and/or the like. Implementing settings includes identifying and implementing values for device settings that could affect the energy use of the device. Values may be binary values (e.g., on/off, 0/1, etc.), values along a range (e.g., 0-10, 0-100%, etc.), values for timeouts for particular settings (e.g., length of time before a screen timeout, length of time before a device sleep mode is implemented, length of time before a particular component is turned off, etc.), ranges of values, or any other value type that can correspond to a device setting. Device settings may include, but are not limited to, fan speed, CPU frequency, GPU affinity, display brightness, display settings, sleep settings, peripheral device or component use or activation (e.g., printers, speakers, headphones, cameras, keyboards, mice, touch panels, image capture devices, audio capture devices, USB ports, etc.) communication settings, communication component activation/deactivation (e.g., short-range wireless communication transmitter/receiver, near-field communication transmitter/receiver, network communication transmitter/receiver, wireless communication transmitter/receiver, etc.), power modes, screen saver, and/or the like. Which device settings can be modified and to what values can be dependent on the user, the entity, and/or the device. Thus, even though a setting may be modifiable, a user or entity could prevent the system from modifying one or more of the device settings.

The system may implement device settings by establishing a maximum value or setting for a particular device setting, for example, processing resources of the device, component usage of the device, and/or the like. In other words, the system may set a cap value for different device settings. Thus, the device can utilize the processing resource or component up to the maximum value or cap value. As an example, the system may set a maximum fan speed which would allow the device to turn on the fan to any speed up to the set fan speed. As another example, the system may set a maximum CPU speed of the CPU. The system may also implement device settings by setting a maximum time for use or nonuse of a processing resource or component. For example, the system may set a maximum time allowance for use of a short-range wireless communication component. As another example, the system may set a maximum time for nonuse of a processing resource before the system takes an action, for example, by shutting of a display after nonuse of the device after a particular length of time. The system may also implement device settings by turning off or on the use of certain processing resources or components. For example, the system may deactivate certain device ports.

At 303, the system determines whether the device settings should be dynamically modified based upon resource requirements. To determine whether the device settings should be dynamically modified, the system may determine whether there is a request for resource requirements of the device that cannot be met by the device with the current device settings. In other words, the system determines if the user is attempting to perform a task that cannot be met by the device with the current system settings. In this case, the system would determine that the device settings need to be increased or modified to allow the user to perform the task or utilize the requested resource. Thus, the system would dynamically modify the resource to allow for increased usage of the resource, usage of the resource, and/or the like. For example, the system may increase the maximum value for a resource, activate a component for use, and/or the like.

Similarly, the system may determine that, based upon the resource requirements for the device requested by the user, the system could reduce or otherwise modify the settings to reduce the energy use of the device. In other words, if the system determines that the user is utilizing the device in a manner which would allow a reduction in resource usage, the system may determine that the settings could be modified to reduce the energy usage of the device, for example, by reducing maximum values for resources, turning off or deactivating resources or components, and/or any other action that would reduce the energy usage of the device. Thus, the system determines if the settings for the device can be modified to decrease energy usage of the device based upon a lack of resource request by the user or need to be modified in order to accommodate a resource request by the user.

To determine whether the device settings could be modified, the system may identify an application being used by the user. In other words, identifying a resource requirement being requested by the user may include identifying one or more applications that the user is currently using. The user may be actively using multiple applications and the resource requirement identification would be based upon the needs of all applications that are being utilized. A user may also have multiple applications open, but may only be utilizing one of the applications. In this case, the system may make the determination based upon the active application or the one the user is utilizing. Identifying an application the user is utilizing may be performed using one or more application identification techniques. For example, the system may utilize gaze tracking to identify what application(s) the user is looking at within a predetermined time frame (e.g., the user may look between open applications within a predetermined time frame, etc.). As another example, the system may keep track of the active applications that occur within a predetermined time frame (e.g., the user may switch between active windows within a predetermined time frame, the device may utilize different active applications within a predetermined time frame, etc.). Any other techniques for identifying applications in use may be utilized.

Based upon the applications being used or activated by the user, the system may identify what resources are needed by application. In other words, based upon the applications being used or activated by the user, the system can identify the resource requirements of the applications. For example, an email application may need less resources than a software coding and compiling application. As another example, a video conference application may need access to an image capture device, whereas a word processing application may not need access to an image capture device. As a final, non-limiting example, a gaming application may need more powerful graphics processing capabilities, whereas an Internet browser may not need such powerful graphics processing capabilities. Identifying what resources are needed may be based upon requirements identified by the application, requirements identified by a user for the application, identification of historical resource requirement usage by the application, and/or the like. If the user is utilizing multiple applications, the system may recognize that the resource requirements are additive across the applications, overlap between the applications, and/or the like. In other words, the system is able to identify the resource requirements for all the applications the user is utilizing so that the user does not detect any performance issues in utilizing the applications.

The system may also, or alternatively, determine resource requirements for the device based upon an environmental context of the device. The environmental context may identify particular resource requirements. An environmental context may identify a context of the user and device and/or environmental factors of the user and device that may influence resource requirements for the device. A context of the user may include, but are not limited to, a location of the user, whether other people are within the same space as the user, a time of day, a day of the week, whether the user is inside a building or outside, and/or the like. Environmental factors may include, but are not limited to, a temperature of the environment, a humidity within the environment, a brightness of the space or environment, the user is within, a noise level within the environment, and/or the like. The environmental factors and the context may be utilized either individually or together to identify the environmental context of the user. The environmental factors and the context could be any characteristics or factors that may provide an indication of how the device should perform.

Different environmental contexts may have different requirements for resource requirements. Thus, a user utilizing the device in different environmental contexts may correspond to resource requirements being requested by the user to utilize the device and the resource requirements can be identified based upon the environmental contexts. For example, if the user is within a hot environment, the device may need to work harder to ensure the device does not overheat. Accordingly, the maximum fan speed may need to be increased as compared to a cooler environment. Thus, the system may need to change the device setting to allow for a higher top end fan speed. As another example, if the user is within a bright environment, the display brightness may need to be adjusted so the user can see the display. Accordingly, the device setting for display brightness may need to be changed to allow for the necessary display brightness. As a final non-limiting example, if the user is within a quiet environment, the user may not want the device to be noisy. Accordingly, the maximum fan speed setting could be decreased to cap the fan speed at a lower speed so the device is not as noisy.

The system may also, or alternatively, identify whether the settings need to be modified or adjusted based upon identification of the user and resource requirements of the identified user. Different characteristics of the user could influence resource requirements for the user. The characteristics could be identified from the user profile, an artificial intelligence model that has learned about the user, crowdsourced information of other users having a similarity to the user, historical information of the user, secondary sources (e.g., email communications, social media posts, calendars of the user, other devices of the user, etc.), information regarding the user captured by the device or other devices (e.g., image capture devices, proximity sensors, accelerometers, gyroscopes, biometric information, gaze tracking sensors, etc.), and/or the like. Some of this information may also be included in the user profile. Among other things, the user profile may identify a role of the user, a department the user works within, tasks to be performed by the user, schedules of the user, and/or the like.

As an example, the schedule may identify when a user is not utilizing a device and the system may then modify the settings to be the most energy efficient during those times. The schedule may also identify when the user performs particular tasks and the system may adjust the device settings to support these tasks at that time. As another example, a role of the user may indicate that the user is a software programmer and the device needs to be able to support the applications needed for software programming. As another example, social media posts of the user may indicate the user is currently on vacation or may be leaving work early. Thus, the system could adjust the settings of the device in view of the fact that the user will not be using the device while on vacation or upon leaving work earlier than usual. As a final, non-limiting, example, a calendar may indicate that the user is in meetings and will need to use video conferencing software. The system may adjust the settings so that an image capture device and audio capture device are accessible and adjust the resources to support the video conferencing software.

The system may also, or alternatively, identify whether the settings need to be adjusted based upon how energy efficient the user has been within the predetermined period. For example, if the predetermined period is a week and the user has not been very energy efficient, the system may adjust the settings in a manner that would allow the user to still meet the energy efficiency budget for the predetermined time period. In other words, while the device settings may not have been normally adjusted based on other factors, due to the fact that the user will not make the energy efficiency budget for the time period without taking additional action with respect to the energy efficiency of the device, the system may identify that a modification should be made to device settings in order to attempt to meet the energy efficiency budget for the predetermined time period.

The system may also identify whether the settings need to be dynamically modified based upon input received from the user. The user may need to override the energy efficiency budget or settings that have been set in connection with the energy efficiency budget. Thus, the user can provide input to override these settings. The input may be provided in the form of the user manually adjusting the settings, the user providing input to the system indicating the energy efficiency settings should be suspended or halted, and/or the user otherwise indicating to the system that the settings need to be overridden. The user may also identify for how long the settings should be overridden. Additionally, or alternatively, the user may provide a second input indicating that the settings should be reverted to be based upon the energy efficiency budget when the user is ready for this. The system may also revert the settings when the device is unused for a particular period of time, when the user is no longer performing a particular task, and/or the like. The user could also provide input to override the energy efficiency budget. In other words, the user can manually adjust the energy efficiency budget and/or allocation of the budget.

If, at 303, the system determines that the device settings do not need to be modified, the system may make no changes at 305. The system may determine that the device settings do not need to be changed if the user is performing tasks that do not require any increases or changes to the resources that are currently available to the user with the current device settings. Similarly, the system may determine that the device settings cannot be decreased, reduced, or further capped based upon the resource requests being made by the user. Thus, the system may take no action to try to reduce the energy usage of the device.

If, on the other hand, the system determines that the device settings do need to be modified at 303, the system may dynamically modify the settings at 304. Dynamically modifying the settings includes adjusting the settings to account for the resource requirements needed by the user. This includes adjusting the settings to be more or less restrictive. In other words, the settings can be adjusted to be more or less energy efficient or more or less based on performance needs. Modifying the settings can be performed in one or more of the same manners as described in connection with implementing the settings.

As an overall non-limiting example of the described system, a company may have energy efficiency goals that they are trying to meet and want to push these goals to employees within the company that use different user devices. The company has an energy efficiency budget generated for the company. Portions of the energy efficiency budget are allocated to the different departments within the company and devices within those departments. As a user utilizes one of these devices, the system implements the device settings and dynamically modifies the settings based upon how the user is utilizing the device and the resources that are utilized and needed by the user when using the device.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
generating, utilizing an efficiency budgeting system, an energy efficiency budget for a computing device;
automatically implementing energy consumption settings for the computing device to meet the energy efficiency budget for the computing device; and
dynamically modifying, using the efficiency budgeting system, the energy consumption settings based upon computational resource requirements for the computing device requested by the user and in view of the energy efficiency budget.

2. The method of claim 1, wherein the generating of the energy efficiency budget comprises generating an entity energy efficiency budget that identifies an efficiency budget for an entity associated with the computing device and allocating a portion of the entity energy efficiency budget to the computing device.

3. The method of claim 2, wherein the generating the entity energy efficiency budget comprises identifying energy goals for the entity and wherein the entity energy efficiency budget is based upon the energy goals.

4. The method of claim 1, wherein the automatically implementing comprises establishing a maximum value for at least one of the energy consumption settings selected from the group consisting of: graphics usage, memory resource usage, central processing unit usage, central processing unit speed, peripheral component usage, sleep settings, inactivity timeouts, and fan speed.

5. The method of claim 1, wherein the dynamically modifying comprises identifying an application being utilized by the user on the computing device and identifying the resource requirements based upon the application.

6. The method of claim 1, wherein the dynamically modifying comprises identifying an environmental context external to the computing device and identifying the resource requirements based upon the environmental context.

7. The method of claim 1, wherein the dynamically modifying comprises identifying the user and identifying the resource requirements based upon the user identified.

8. The method of claim 7, wherein the dynamically modifying comprises identifying a schedule of the user identified and wherein the identifying the resource requirements is based upon the schedule of the user identified.

9. The method of claim 1, comprising receiving input from the user to override the settings and wherein the dynamically modifying is based upon the input.

10. The method of claim 1, wherein the generating of the energy efficiency budget comprises generating of the energy efficiency budget for a predetermined time period.

11. A system, the system comprising:
a processor;
a memory device that stores instructions that, when executed by the processor, causes the system to:
generate, utilizing an efficiency budgeting system, an energy efficiency budget for a computing device;
automatically implement energy consumption settings for the computing device to meet the energy efficiency budget for the computing device; and
dynamically modify, using the efficiency budgeting system, the energy consumption settings based upon computational resource requirements for the computing device requested by the user and in view of the energy efficiency budget.

12. The system of claim 11, wherein the generating of the energy efficiency budget comprises generating an entity energy efficiency budget that identifies an efficiency budget for an entity associated with the computing device and allocating a portion of the entity energy efficiency budget to the computing device.

13. The system of claim 12, wherein the generating the entity energy efficiency budget comprises identifying energy goals for the entity and wherein the entity energy efficiency budget is based upon the energy goals.

14. The system of claim 11, wherein the automatically implementing comprises establishing a maximum value for at least one of the energy consumption settings selected from the group consisting of: graphics usage, memory resource usage, central processing unit usage, central processing unit speed, peripheral component usage, sleep settings, inactivity timeouts, and fan speed.

15. The system of claim 11, wherein the dynamically modifying comprises identifying an application being utilized by the user on the computing device and identifying the resource requirements based upon the application.

16. The system of claim 11, wherein the dynamically modifying comprises identifying an environmental context external to the computing device and identifying the resource requirements based upon the environmental context.

17. The system of claim 11, wherein the dynamically modifying comprises identifying the user and identifying the resource requirements based upon the user identified.

18. The system of claim 17, wherein the dynamically modifying comprises identifying a schedule of the user identified and wherein the identifying the resource requirements is based upon the schedule of the user identified.

19. The system of claim 11, comprising receiving input from the user to override the energy efficiency budget and dynamically modifying the energy efficiency budget for a time period based upon the input.

20. A product, the product comprising:
a computer-readable storage device that stores executable code that, when executed by a processor, causes the product to:
generate, utilizing an efficiency budgeting system, an energy efficiency budget for a computing device;
automatically implement energy consumption settings for the computing device to meet the energy efficiency budget for the computing device; and
dynamically modify, using the efficiency budgeting system, the energy consumption settings based upon computational resource requirements for the computing device requested by the user and in view of the energy efficiency budget.
